(19) United States
(12) Patent Application Publication
(10) Pub. No.: US 2026/0256312 A1
(43) Pub. Date: Sep. 3, 2026

(54) METHOD OF BREWING A BEVERAGE

(71) Applicant: PLAE 2 TECH AB, Arvika (SE)

(72) Inventor: Anders Eriksson, Arvika (SE)

(73) Assignee: PLAE 2 TECH AB, Arvika (SE)

(21) Appl. No.: 18/993,137

(22) PCT Filed: Jul. 11, 2023
(86) PCT No.: PCT/SE2023/050730

§ 371 Date: Jan. 10, 2025

(30) Foreign Application Priority Data
Jul. 12, 2022 (SE) 2250894-9

(51) Int. Cl. A47J 31/00; A47J 31/41; A47J 31/52

(52) U.S. Cl. CPC A47J 31/002; A47J 31/41; A47J 31/5253

(57) ABSTRACT

This invention relates to a method of brewing tea, comprising the steps of providing a processor-controlled brewing unit (1), including a brewing device (M), a brewed-tea container (N), at least one heating device (F, G), at least one water inlet supply device (A) and a control unit (P), which control unit is arranged to control the amount of water and temperature of water supplied to said brewing device (M), wherein said control unit (P);
In a first phase (P2) controls supply of a first amount of hot water (HW, T>70°) to said brewing device (M),
In a second phase (P3) controls supply of at least one second amount of cold water (CW, T<30°) or at least one first amount of warm water (WW, 70°>T>30°), to said brewing device (M),
In a third phase (P4) controls supply of a second amount of hot water (HW, T>70°) to said brewing device (M), and
In a fourth phase (P5) controls supply of at least one third amount of cold water (CW, T<30°) or at least one second amount of warm water (WW, 70°>T>30°), to said brewing device,
and controls flow and time span of said supplies to obtain a brewed tea in said brewed-tea container (3) having a temperature (TC) that is below 40°.

### TECHNICAL FIELD

The present invention relates to a process and a system for brewing a beverage, preferably tea such as filter tea.

### BACKGROUND OF THE INVENTION

A variety of brewing apparatuses have been developed utilizing methods of distributing water over a brewing substance. In some of these systems, water is controllably turned on and off to dispense water during the production of a beverage. For instance, U.S. Pat. No. 4,969,392 relates to a coffee machine in which water is retained in a temperature-controlled container whereupon water, when at sufficient temperature, is dispensed on the ground coffee to initiate a brewing process.

From EP-3307118 there is known a process and a system for brewing a beverage in which the temperature control is safeguarding an accurate contact temperature of water and brewing substance.

### SUMMARY OF THE INVENTION

It is an object of the invention to provide an improved automated process for brewing cold tea, wherein the flavor of the tea may be improved in comparison with known automated processes, which is achieved by means of a process as defined in claim 1.

In general the invention is based on a method of brewing tea, comprising the steps of providing a processor-controlled brewing unit (1), including a brewing device (M), a brewed-tea container (N), at least one heating device (F, G), at least one water inlet supply device (A) and a control unit (P), which control unit is arranged to control the amount of water and temperature of water supplied to said brewing device (M), wherein said control unit (P);
In a first phase (P2) controls supply of a first amount of hot water (HW, T>70°) to said brewing device (M),
In a second phase (P3) controls supply of at least one second amount of cold water (CW, T<30°) or at least one first amount of warm water (WW, 70°>T>30°), to said brewing device (M),
In a third phase (P4) controls supply of a second amount of hot water (HW, T>70°) to said brewing device (M), and
In a fourth phase (P5) controls supply of at least one third amount of cold water (CW, T<30°) or at least one second amount of warm water (WW, 70°>T>30°), to said brewing device,
and controls flow and time span of said supplies to obtain a brewed tea in said brewed-tea container (3) having a temperature (TC) that is below 40°.

Further preferable aspects of the invention are apparent from the independent claims.

### BRIEF DESCRIPTION OF FIGURES

In the following the invention will be described with reference to the enclosed figures, where:

FIG. 1 schematically shows an exemplary system that may be used in accordance with the invention, and,

FIG. 2 shows a diagram with exemplary graphs describing a brewing cycle in accordance with one embodiment of the invention.

### DETAILED DESCRIPTION

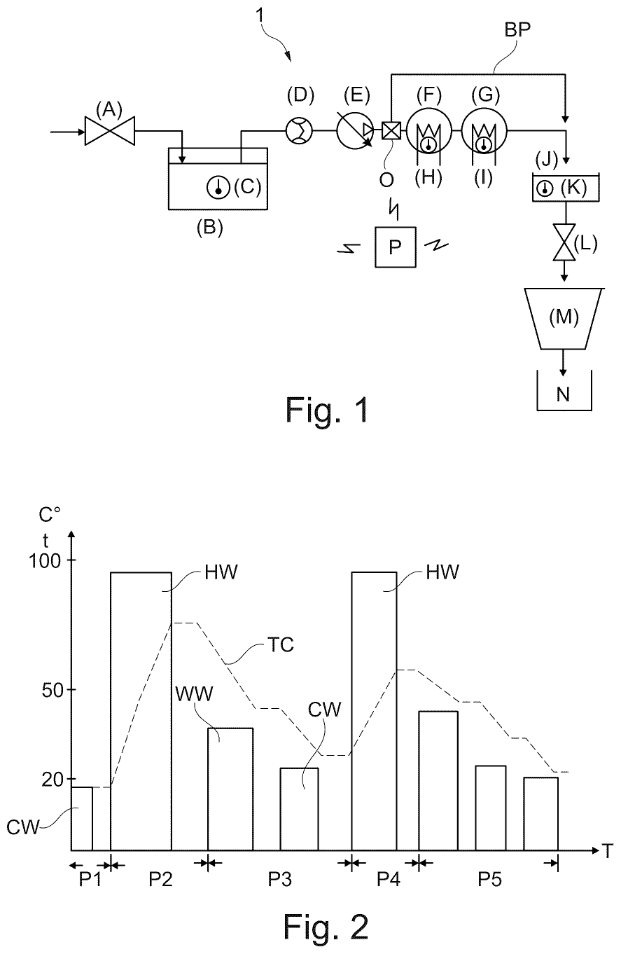

FIG. 1 schematically illustrates an exemplary system that may be used for the invention. It is shown that the flow of water may be supplied via an inlet valve A and subsequently an optional air breaker B eliminating or at least reducing the amount of bubbles in the water. An inlet temperature sensor C is mounted in the air breaker (or elsewhere upstream the water heating device) to determine the inlet temperature of water entering into the water heating device (here illustrated by heating blocks F and G in which corresponding sensors H and I for determining the temperature are mounted). Sensors C, H and I may be coupled to a controller P to which they send temperature input data. A pump E may be arranged upstream the heating device, which may comprise two heating blocks F and G. Preferably, a flow meter D, such as a pulser is also provided. Preferably the flow meter D and means for feeding water, such as the pump E, are arranged upstream the water heating device.

The flow pulser and the pump are in communication with the controller P which can regulate the flow rate of water based on input data, e.g. from the temperature sensors. Downstream from the water heating device a water dispenser J may be arranged in which a further temperature sensor K may be mounted. The predetermined temperature in the dispenser J can be assumed to be the same or at least very close to the contact temperature of water and beverage substance in the brewing device M where suitably a filter (not shown) may be arranged, such as a tea filter holding tea.

The water dispenser J may be equipped with a valve L downstream of which the brewing device M is arranged. The valve L is likewise in communication with the controller so as to enable opening and closing thereof, for example to enable operation of manually set or preprogrammed brewing cycles whereby the valve is opened and closed respectively depending on the program performed. In the substance container the mixing of hot water and brewing substance is carried out to produce the beverage exiting at the arrow into the brewed-tea container N below the brewing device M. The invention being thus described, it will be obvious that the same may be varied in many ways. Such variations are not to be regarded as a departure from the gist and scope of the present invention, and all such modifications as would be obvious to one skilled in the art are intended to be included within the scope of the claims.

In FIG. 2 there is shown a diagram presenting graphs that represent an exemplary embodiment of the invention. One of the graphs presents the temperature of the tea that is being brewed within the tea-brew-vessel N. The other graph presents supply of batches of water to the brewing device M, and the temperature for each batch. Along the X-axis there is shown the time and along the Y-axis there is shown the temperature. As can be noted in the preferred embodiment there is a pre-phase P1, where an amount of cold water is supplied to the brewing device M. Thereby the brewed tea may be improved, in some applications, i.e. to pre-wet the tea before the actual brewing. However, this pre-phase P1 of a brewing cycle may be optional. In some applications it has shown to be an advantage

In a first phase P2 there is added a pre-defined amount of hot water HW to the brewing device M. The addition of that hot water HW is controlled by the control unit P, which in traditional manner controls pump and heating blocks to supply a pre-defined amount of hot water, i.e. above 70 C°, having a pre-define temperature to the brewing device M. In most applications it is preferred that the hot water HW has a temperature in the range of 85-98° C., more preferred applications red 90-96° C. When the hot water is supplied to the brewing device M brewed teat will start flowing through the brewing device M into the tea-brew-vessel N. As can be noted, the temperature within the tea-brew-vessel M will then rise from a temperature substantially corresponding to the room and/or tap water, to a temperature that is closer to a temperature that is within the range warm, i.e. 30-70 C° water.

There are three different temperatures ranges defined for more clearly describing the invention, i.e. hot water HW meaning water warmer than 70° C., warm water WW meaning water having a temperature in the range of 30-70° C. and cold water CW being colder than 30° C.

For example, the temperature at the end of the first phase P2 may be around 70° C. Thereafter there follows a second phase P3 where warm WW or cold water CW is supplied in batches to the brewing device M. As can be seen in the exemplary embodiment shown in FIG. 2 the temperature of the first batch in the second phase P3 has a higher temperature than the second batch that will be supplied later within the second phase P3. The reason for the differing temperatures in this example is that the water is supplied via the heating device F, G. At this phase the heating device F, G is not active and accordingly it is cooling down and will be extra cooled when the water flows therethrough. As a consequence, the first batch in the second phase P3 will be supplied at a higher temperature than the second batch. The first batch will have a temperature that is defined as warm, i.e. warm water WW, which is water in the range of 30-70° C. The second batch will be supplied at a lower temperature, in this application it is about the same as the tap water, i.e. cold water CW. Accordingly the temperature TC within the tea-brew-vessel N will at the end of phase 3 be lowered to a level, as shown in the diagram as shown in the second phase P3.

In a third phase P4 again hot water HW is supplied to the brewing device M. As can be noted the temperature within the tea-brew-vessel N will then rise again to a level corresponding to be within the warm temperature range. The effect of the second batch of hot water HW, e.g having a temperature of slightly above 70° C. may be two-fold. Firstly, it may trigger further extraction of aroma from the tea to improve taste of the final brew. Secondly it may also assist in providing a better flow through the filter. The reason for possibly improving flow is that the hot water HW in the second batch may dissolve material that has been clogged within the filter. Hence, the hot water HW in the third phase P4 may improve through-flow through the brewing device M and/or improve aroma of the brewed beverage.

Then there follows a fourth phase P5 wherein batches of warm WW and/or cold water CW is supplied to the brewing device M. In a similar manner as described in the second phase P3, the batches supplied will have a successively lower temperature due to the chilling effect of the heating device F, G of the batches. Hence, the batches will be colder and colder and as a consequence also the brewed beverage in the tea-brew-vessel N will have a temperature TC that is lower and lower. At the end of the brewing cycle the temperature of the beverage is supposed to be at the pre-defined temperature, which is controlled by the control unit P of the brewing unit 1. Accordingly, the control unit P has a pre-selected algorithm that will control supply of a sufficient amount of cold batches within the fourth phase P5 to obtain a final predefined temperature of the tea, in accordance with the invention.

When the brewing cycle is finalized, there is a need to remove the used rest of the tea from the brewing device, i.e. from the filter (not shown) therein. This may be achieved in different manners. For instance, there may be use of disposable filters and the used filter is then removed and replaced by a new filter, e.g. having a predefined amount of fresh tea therein. It is foreseen that this handling may be automatically handled by the brewing unit and that the control unit P is pre-programmed to control adapted mechanisms to remove the old filter and supply a new one. In an alternate embodiment there is use of a permanent filter that is arranged in a manner within the brewing unit to facilitate emptying and cleaning of the filter after each brewing cycle.

Furthermore, as is shown in FIG. 1 that there may be arranged a bypass line BP that bypasses the heating device F, G. This may be arranged by providing a valve O after the pump E and arranging for the control unit P to control the valve O to bypass the heating device F, G when cold water CW batches are to be supplied to the brewing device M. In such an embodiment there will be no batches of warm water WW supplied to the brewing device M (contrary to FIG. 2) but instead merely cold-water batches supplied to the brewing device M. Hence, in such an embodiment the curve presenting the temperature TC of the beverage in the tea-brew-vessel N will have a more acute angle than shown in FIG. 2, resulting in the possibility to more quickly adjust from a higher temperature to a set temperature of the brewed tea.

It is evident that in some applications it may be sufficient to merely use one batch of cold water in the second phase P3 and/or in the fourth phase P5, but preferably a plurality of batches of cold-water DC are supplied at least in the fourth phase P5. It is evident that the amount that is supplied in each batch may vary depending on desires and also that the time in-between supply of the batches may vary.

The term “beverage” is especially intended to define tea, but may also include e.g. herbs, coffee as well as other substances and any other form of beverages. Settings of the process preferably include preprogrammed recipes selected according to the type of tea to be brewed, but may also include manual settings to adjust suitable taste characteristics thereof. The use of a water dispenser J is optional, i.e. the water may flow directly from the heater device F, G into the brewing device M. The term “water dispenser” is intended to include any dispenser which may accumulate water during a certain period of time thereby functioning as a water container or reservoir prior to dispense of said water. According to one embodiment, the water dispenser is equipped with means for controlling dispense of water, e.g. a valve. Water may thus either accumulate for a certain period of time in said dispenser or continuously pass through the dispenser depending on the setting of e.g. said valve regulating the flow of water through the dispenser

According to one embodiment, the water heating device is controlled to transfer a substantially constant amount of heat to water introduced into the system. By maintaining the transfer of heat substantially constant, a more controlled and stable process can be provided. Preferably, the flow rate of water may fluctuate up to 10%, preferably up to 5%, and most preferably up to 1% from its calculated set-point during the brewing process. By maintaining the heating of water substantially constant, a more stable process may be obtained enabling a stable flow of water to the water dispenser. According to one embodiment, a sensor, for example a temperature sensor, is arranged in the water heating device so as to monitor and measure the transfer of heat to water. The sensor may be coupled to a controller controlling changes in water temperature.

According to one embodiment, at least two water heating devices are connected in series. Preferably, each of said at least two water heating devices are equipped with a sensor for measuring the temperature coupled to a controller.

According to one embodiment, the control unit P controls the timing, flow rate, temperature of water and other characteristics of driving or moving water, preferably by pumping by the pump mechanism.

According to one embodiment, a device for reducing or eliminating air bubbles, e.g. an air breaker, is arranged upstream the means for controlling flow of water.

By means of the control unit, various settings and preprogrammed recipes can be provided. This means that for example a combination of brewing cycles performed at different temperatures and flow rates may be performed to influence the characteristics of the tea.

1. A method of brewing tea, comprising the steps of providing a processor-controlled brewing unit (1), including a brewing device (M), a brewed-tea container (N), at least one heating device (F, G), at least one water inlet supply device (A) and a control unit (P), which control unit is arranged to control the amount of water and temperature of water supplied to said brewing device (M), wherein said control unit (P);
in a first phase (P2) controls supply of a first amount of hot water (HW, T>70°) to said brewing device (M),
in a second phase (P3) controls supply of at least one second amount of cold water (CW, T<30°) or at least one first amount of warm water (WW, 70°>T>30°), to said brewing device (M),
in a third phase (P4) controls supply of a second amount of hot water (HW, T>70°) to said brewing device (M), and
in a fourth phase (P5) controls supply of at least one third amount of cold water (CW, T<30°) or at least one second amount of warm water (WW, 70°>T>30°), to said brewing device,
and controls flow and time span of said supplies to obtain a brewed tea in said brewed-tea container (3) having a temperature (TC) that is below 40°.

2. The method according to claim 1, wherein in a pre-phase (P1) before said first phase (P2) controls supply of a first amount of cold water (CW, T<30°) to said brewing device (M),

3. The method according to claim 1, wherein said second phase (P3) incudes supply of a plurality of amounts of cold water (CW, T<30°) and/or warm water (WW, 70°>T>30°).

4. The method according to claim 1, wherein said third phase (P4) is initiated when the flow out from said brewing device (M) in said second phase (P3) is less than 70% of the initial flow during said first phase (P2), wherein preferably said third phase (P4) is initiated when the flow out from said brewing device (M) in said second phase (P3) is less than 50% of the initial flow during said first phase (P2).

5. The method according to claim 1, wherein said third phase (P4) is initiated when the temperature of tea in said brewed-tea container (N) reaches a calculated pre-set temperature that is in the range of 10°-40°, preferably at or below 30°.

6. The method according to claim 1, wherein said fourth phase (P5) includes supply of a plurality of amounts of cold water (CW, T<30°) and/or warm water (WW, 70°>T>30°).

7. The method according to any claim 6, wherein there is included a supply of a plurality of amounts of cold water (CW, T<30°).

8. The method according to claim 6, wherein there are more amounts of supply of cold water (CW, T<30°) in said fourth phase (P5) than in said second phase (P3).

9. The method according to claim 1, wherein said fourth phase is terminated when the temperature of tea in said brewed-tea container (3) reaches a calculated pre-set temperature that is in the range of 0°-30°, preferably in the range of 10-25°.

10. The method according to claim 7, wherein ice and/or cold water (CW, T<30°) is added separately to said brewed-tea container (N).

11. The method according to claim 1, wherein said brewing device (M) includes a filter, wherein said filter is washable, wherein preferably the process automatically cleans said a washable filter after each finalized brewing.

12. The method according to claim 1, wherein said brewing device (M) includes a filter which is disposable, wherein preferably the process automatically renews said a disposable filter after each finalized brewing.

13. A method of brewing tea, comprising the steps of providing a processor-controlled brewing unit (1), including a brewing device (M), a brewed-tea container (N), at least one heating device (F, G), at least one water inlet supply device (A) and a control unit (P), which control unit is arranged to control the amount of water and temperature of water supplied to said brewing device (M), wherein said control unit (P);
in a first phase (P2) controls supply of a first amount of hot water (HW, T>70°) to said brewing device (M),
in a second phase (P3) controls supply of at least one second amount of cold water (CW, T<30°) or at least one first amount of warm water (WW, 70°>T>30°), to said brewing device (M),
in a third phase (P4) controls supply of a second amount of hot water (HW, T>70°) to said brewing device (M), and
in a fourth phase (P5) controls supply of at least one third amount of cold water (CW, T<30°) or at least one second amount of warm water (WW, 70°>T>30°), to said brewing device,
and controls flow and time span of said supplies to obtain a brewed tea in said brewed-tea container (3) having a temperature (TC) that is below 40°; and
wherein said third phase (P4) is initiated when the flow out from said brewing device (M) in said second phase (P3) is less than 70% of the initial flow during said first phase (P2), wherein preferably said third phase (P4) is initiated when the flow out from said brewing device (M) in said second phase (P3) is less than 50% of the initial flow during said first phase (P2).

14. The method according to claim 13, wherein said third phase (P4) is initiated when the temperature of tea in said brewed-tea container (N) reaches a calculated pre-set temperature that is in the range of 10°-40°, preferably at or below 30°.

15. The method according to claim 13, wherein said fourth phase (P5) includes supply of a plurality of amounts of cold water (CW, T<30°) and/or warm water (WW, 70°>T>30°).
